(19) United States
(12) Patent Application Publication
(10) Pub. No.: US 2014/0116063 A1
(43) Pub. Date: May 1, 2014

(54) ADVANCED COMBINED CYCLE SYSTEMS AND METHODS BASED ON METHANOL INDIRECT COMBUSTION

(71) Applicants: Shimin Deng, Oakville (CA); Ruairi P. Hynes, Oakville (CA)

(72) Inventors: Shimin Deng, Oakville (CA); Ruairi P. Hynes, Oakville (CA)

(73) Assignee: HATCH LTD., Mississauga, ON (CA)

(21) Appl. No.: 14/232,147

(22) PCT Filed: Jul. 10, 2012
(86) PCT No.: PCT/CA2012/000663

§ 371 Date: Jan. 10, 2014

Related U.S. Application Data
(60) Provisional application No. 61/506,428, filed on Jul. 11, 2011.

(51) Int. Cl. F01K 23/10; F02C 3/24

(52) U.S. Cl. CPC F01K 23/10; F02C 3/24
USPC 60/780; 60/39.182; 60/39.461

(57) ABSTRACT

A methanol indirect combustion combined-cycle power generation apparatus and method. A liquid methanol input stream is evaporated to provide a gaseous methanol stream which is converted to syngas that is combusted in a gas turbine assembly to drive a first electrical generator and produce an exhaust gas. Heat from the exhaust gas of the gas turbine assembly is used to produce first and second steam streams. The first steam stream drives a first steam turbine and provides the heat required for converting the gaseous methanol stream to the syngas combustion stream. The second steam stream drives a second steam turbine and provides the heat required for evaporating the liquid methanol input stream. A second electrical generator is driven using at least one of the first and second steam turbines.

### FIELD

The present subject matter relates generally to combined cycle power generation systems and methods utilizing methanol indirect combustion.

### INTRODUCTION

U.S. Pat. No. 5,927,063 (Janda) discloses a high efficiency reformed methanol (syngas) gas turbine power plant. The plant utilizes a Back Pressure steam Turbine (BPT) to maximize the thermal efficiency and the power output of a reformed methanol gas turbine power generation system. Methanol feed is reformed to syngas (H₂ and CO₂) prior to combustion in the gas turbine. The endothermic reforming reaction, and the generation of the significant amount of process steam essential for reforming, recovers most of the useful heat in the gas turbine exhaust gas. The process steam pressure is set by the gas turbine inlet requirements, and can be referred to as low pressure steam. Additional heat in the gas turbine exhaust gas is recovered by generating the system's process steam at an elevated pressure, rather than at the required low pressure. This high pressure steam is used to drive the BPT, generating additional power and the discharged low pressure steam from the BPT is used as the process steam for the methanol reformer.

U.S. Pat. No. 5,819,522 (Topsoe) discloses an improved process for generating power in a gas turbine cycle comprising an air compression stage, a fuel gas combustion stage and an expansion stage providing mechanical power in a rotating power generator. The improvement is based on recovering heat contained in exhaust gas from the expansion step by means of endothermic catalytic conversion of a primary fuel comprising dimethyl ether and/or methanol with water to a gas comprising hydrogen and carbon monoxide and employing at least a part of that gas as a fuel in the fuel gas combustion stage.

### SUMMARY

Methanol can be used as a fuel in power generation systems including, for example, combined cycle power plants. Methanol may be used as an alternative to traditional fossil fuels (including, for example oil and natural gas) and can be produced from non-petroleum based materials, including, for example, coal. The use of methanol as a fuel source to generate electrical power may be advantageous in regions that have limited access to, or quantities of, fossil fuels. Methanol may also be desirable as an alternative to accessible fossil fuel supplies for a variety of reasons including, for example, cost, transportability and environmental factors.

When using methanol as a fuel source, it is generally desirable to operate the power generation plant at a relatively high level of efficiency. Improving or increasing the operating efficiency of the power generation plant may increase the amount of electricity generated per unit of fuel input. For example, this may allow existing power supply requirements to be met using a smaller quantity of fuel, and/or may allow an existing quantity of fuel to produce a larger amount of electricity. Methanol can be introduced directly into a gas turbine assembly (direct combustion) or can first be converted into a different fuel material, such as syngas (indirect combustion).

In a combined cycle power generation apparatus, an incoming fuel material is burned in a gas turbine assembly. Mechanical work produced by the gas turbine assembly is used to drive an electrical generator. Efficiency of combined cycle apparatus are elevated, relative to a single cycle apparatus, because thermal energy from the hot exhaust gases exiting the gas turbine assembly is used to generate steam, which in turn is used to drive one or more steam turbines. Mechanical work produced by the steam turbines can be used to generate additional electrical power.

Efficiency of a combined cycle power generation apparatus may be further increased by recapturing at least some of the thermal energy of the steam by using the steam to provide heat at another location in the system including, for example, upstream from gas turbine assembly.

Existing combined cycle power system has utilized the thermal energy of exhaust steam of the BPT (i.e. low quality steam that is exiting the BPT assembly) to provide heat for preheating the fuel material or converting methanol into syngas. Utilizing exhaust steam (as opposed to using steam that has not yet passed through a turbine) helps maximize the amount of work produced by the steam turbine assembly.

Another known combined cycle power system has utilized the thermal energy of exhaust stream of the gas turbine assembly to provide heat for preheating the fuel material or converting methanol into syngas. Utilizing exhaust stream (as opposed to waste/discharge to atmosphere) may help increase efficiency. However, extracting the gas turbine exhaust stream (which has a high temperature) may also cause relatively high losses in overall system efficiency in compared to using exhaust steam from a steam turbine.

In contrast to the conventional approach, the inventors have discovered that indirect combustion power generation apparatus efficiency may be generally maintained, and may be increased, by extracting two steam streams from the steam turbine assembly to provide some, or preferably all, of the heat required to process the methanol fuel prior to introducing it to the gas turbine assembly (e.g. heating, evaporation and conversion). The inventors have discovered that the use of two extracted steam streams drawn from separate locations in the steam turbine assembly, can improve the efficiency of the methanol evaporation and conversion processes to an extent that is generally sufficient to offset the losses in steam turbine output (due to the extraction of the stream). The first extracted steam stream can be at a temperature that is lower than the exhaust gas from the gas turbine assembly, but can be similar to the temperature steam extracted from a BPT. The second extracted steam stream is at a lower temperature than the first extracted steam stream. In this configuration, a combination of relatively lower quality extracted steam streams can be used in place of the conventional, relatively high quality steams (e.g. gas turbine exhaust and/or BPT steam), which may result in improved overall efficiency.

According to one broad aspect of the present subject matter, a methanol indirect combustion combined-cycle power generation apparatus can include an evaporation apparatus operable to evaporate a liquid methanol input stream to provide a gaseous methanol stream. The evaporation apparatus can include a liquid inlet for receiving the liquid methanol stream and a gas outlet for discharging the gaseous methanol stream. The apparatus can also include a conversion apparatus connected downstream from the evaporation apparatus and operable to convert the gaseous methanol stream into a syngas combustion stream. The conversion apparatus can include a gaseous methanol inlet fluidly coupled to the gas outlet of the evaporation apparatus and a syngas combustion stream outlet. The apparatus can also include a gas turbine assembly fluidly coupled to the combustion stream outlet and configured to burn the syngas combustion stream. The gas turbine assembly can have an exhaust outlet and can be drivingly connectable to a first electric generator.

The apparatus can also include a heat recovery steam generator (HRSG) that includes an exhaust inlet fluidly coupled to the exhaust outlet and configured to receive an exhaust gas stream from the gas turbine assembly and to use the heat from the exhaust gas stream to generate steam. The HSRG can include a first steam outlet and a second steam outlet. The apparatus can also include a steam turbine assembly connected to and configured to receive steam from the HSRG and be drivingly connectable to at least a second electrical generator. The steam turbine assembly can include a first steam turbine having a first steam inlet fluidly coupled to the first steam outlet on the HRSG. The first steam turbine has a first extraction outlet for extracting a first extracted steam stream from the first steam turbine and a first exhaust outlet. The first extraction outlet can be fluidly coupled to a first steam inlet on the conversion apparatus to route the first extracted steam stream to the conversion apparatus. The heat provided to the conversion apparatus via the first extracted steam stream can be sufficient to facilitate conversion of the gaseous methanol stream into the combustion feed stream. The steam turbine assembly can also include a second steam turbine having a second steam inlet fluidly coupled to the second steam outlet on the HRSG. The second steam turbine includes a second extraction outlet for extracting a second extracted steam stream from the second steam turbine and a second exhaust outlet. The second extraction outlet can be fluidly coupled to a second steam inlet on the evaporation apparatus to route the second extracted steam stream to the evaporation apparatus. The heat provided to the evaporation apparatus via the second extracted steam stream can be sufficient to evaporate the liquid methanol input stream.

The apparatus can also include a first recycle condensate outlet on the conversion apparatus that is fluidly coupled to a first recycle condensate inlet on the evaporation apparatus to transfer a first recycle condensate stream from the conversion apparatus to the evaporation apparatus to provide additional heat to the evaporation apparatus.

The first recycle condensate stream can be at a first recycle temperature that is hotter than the operating temperature of the evaporation apparatus.

The evaporation apparatus can include a preheater, for receiving and pre-heating the liquid methanol input stream and an evaporator fluidly coupled downstream from the preheater for evaporating the liquid methanol input stream received from the preheater, with the evaporator comprising the second steam inlet for receiving the second extracted steam stream.

The apparatus can also include a second recycle condensate outlet on the evaporator fluidly coupled to a second recycle condensate inlet on the preheater to transfer a second recycle condensate stream from the evaporator to the preheater to provide heat to pre-heat the liquid methanol input stream.

The conversion apparatus can include a decomposition reactor, and the syngas combustion stream produced by the decomposition reactor can comprise hydrogen and carbon monoxide.

The conversion apparatus can include a reformer, and the syngas combustion stream produced by the reformer can comprise hydrogen and carbon dioxide. Optionally, the reformer can be a steam reformer. If a steam reformer is used, the first extracted steam stream can be split to provide two steam inputs to the reformer: one as a reaction agent and the other as a heat source.

The apparatus can also include a separator apparatus fluidly connected between the reformer and the gas turbine assembly. The separator apparatus can be operable to separate carbon dioxide from the syngas combustion stream prior to introducing the syngas combustion stream to the gas turbine assembly.

The separator apparatus can include a physical absorption carbon dioxide separator.

The apparatus can also include a condenser apparatus fluidly coupled between the second exhaust outlet on the second steam turbine and the HRSG, in which exhaust steam from the second steam turbine is condensed into condensate, optionally at vacuum pressure.

The first extracted steam stream can be between about 10 percent and about 70 percent of the quantity of steam provided to the first steam turbine.

The second extracted steam stream can be between about 5 percent and about 35 percent of the quantity of steam provided to the second steam turbine.

The first extracted steam stream can be at a first temperature and the second extracted steam stream can be at a second temperature that is lower than the first temperature.

According to another broad aspect of the present subject matter, a method of generating power in a combined-cycle power generation plant can include the steps of: a) evaporating a liquid methanol input stream to provide a gaseous methanol stream; b) converting the gaseous methanol stream to a syngas combustion stream; c) combusting the syngas combustion stream in a gas turbine assembly to drive a first electrical generator and generate an exhaust gas stream; d) generating at least first and second steam streams using heat from the exhaust gas stream; e) driving a first steam turbine using the first steam stream; f) extracting a first extracted steam stream from the first steam turbine and using the first extracted steam stream to provide the heat required for converting the gaseous methanol stream to the syngas combustion stream; g) driving a second steam turbine using the second steam stream; h) extracting a second extracted steam stream from the second steam turbine and using the second extracted steam stream to provide the heat required for evaporating the liquid methanol input stream; and i) driving a second electrical generator using at least one of the first and second steam turbines.

The method can also include withdrawing a first recycle condensate stream from the conversion apparatus and using the first recycle condensate stream to provide additional heat to evaporate the liquid methanol input stream.

Evaporating the liquid methanol input stream can include passing the liquid methanol input stream through a preheater and an evaporator, and the second extracted steam stream can provide heat to the evaporator.

The method can also include withdrawing a second recycle condensate stream from the evaporator and using the second recycle steam stream to provide heat to the preheater.

Converting the gaseous methanol stream to a syngas combustion stream can include processing the gaseous methanol stream in a decomposition reactor so that the syngas combustion stream comprises hydrogen and carbon monoxide.

Converting the gaseous methanol stream to a syngas combustion stream can include processing the gaseous methanol stream in a reformer so that the syngas combustion stream comprises hydrogen and carbon dioxide.

The method can also include separating at least a portion of the carbon dioxide from the syngas combustion stream prior to combusting the syngas combustion stream in the gas turbine assembly.

The carbon dioxide can be separated from the syngas combustion stream using a physical absorption carbon dioxide separator.

The first extracted steam stream can be extracted at a first temperature and the second extracted steam stream can be extracted at a second temperature that is lower than the first temperature.

Optionally, the first extracted steam stream can provide substantially all of the heat required to convert the gaseous methanol stream to the syngas combustion stream.

### DRAWINGS

The drawings included herewith are for illustrating various examples of the present subject matter and are not intended to limit the scope of what is taught in any way. In the drawings:

FIG. 1 is a schematic drawing of an example of a power generation apparatus;

FIG. 2 is a schematic drawing of another example of a power generation apparatus;

FIG. 3 is a schematic drawing of yet another example of a power generation apparatus;

FIG. 4 is a schematic drawing of yet another example of a power generation apparatus;

FIG. 5 is a schematic drawing of an example of a separator apparatus;

FIG. 6 is a flow chart illustrating a method of operating a power generation apparatus;

FIG. 7 is a schematic drawing illustrating conventional power generation apparatuses;

FIG. 8 is an energy level vs. temperature diagram;

FIG. 9 is a simulated heat transfer profile diagram; and

FIG. 10 is another simulated heat transfer profile diagram.

### DESCRIPTION OF VARIOUS EMBODIMENTS

Various apparatuses or processes will be described to provide examples of the claimed subject matter. No embodiment limits the claimed subject matter and the claims may cover processes or apparatuses that differ from those described below.

Methanol may be used as a fuel source in power generation systems. One such use of methanol is to produce power by providing methanol fuel directly into a gas turbine. Another possible use is to convert an incoming methanol stream into a different type of fuel, for example a syngas stream, that can be supplied to a gas turbine. This process can be referred to as methanol indirect combustion.

Methanol indirect combustion (converting methanol into fuel gas or syngas before combustion) may be one way to improve power generation efficiency as compared to conventional methanol combustion in combined cycle power generation systems.

Examples of methanol indirect combustion can include a variety of different chemical conversion reactions, including, for example, methanol decomposition (dry methanol cracking) and methanol steam reforming.

Using the methanol decomposition reaction, gaseous methanol can be catalytically decomposed to carbon monoxide and hydrogen, for example using a suitable decomposition reactor, according to the reaction:

CH₃OH=CO+2H₂ (1)

which may take place rapidly with respect to temperature. Pressure may hinder the decomposition process, and higher temperatures may be required when system operating pressure increases.

Using methanol reformation, methanol can be catalytically steam-reformed, for example using a steam reformer, according to the reaction:

CH₃OH+H₂O=CO₂+3H₂ (2)

This reaction may take place over a catalyst being active above 200° C. and at the same time, the catalyst may not be active for the reverse reforming reaction (methanation). It may be possible to achieve full conversion at relatively low temperatures.

The reaction products resulting from both i) methanol decomposition, and ii) methanol reformation (e.g. hydrogen and carbon monoxide, or hydrogen and carbon dioxide) can both be considered as examples of “syngas” throughout this description.

In some instances, releasing large quantities of carbon dioxide (which is commonly referred to as a greenhouse gas) into the atmosphere or environment surrounding the power generation apparatus may be undesirable. In such instances, the power generation apparatus may be equipped with a carbon dioxide separator that can separate carbon dioxide from the syngas, preferably at a location upstream from the gas turbine.

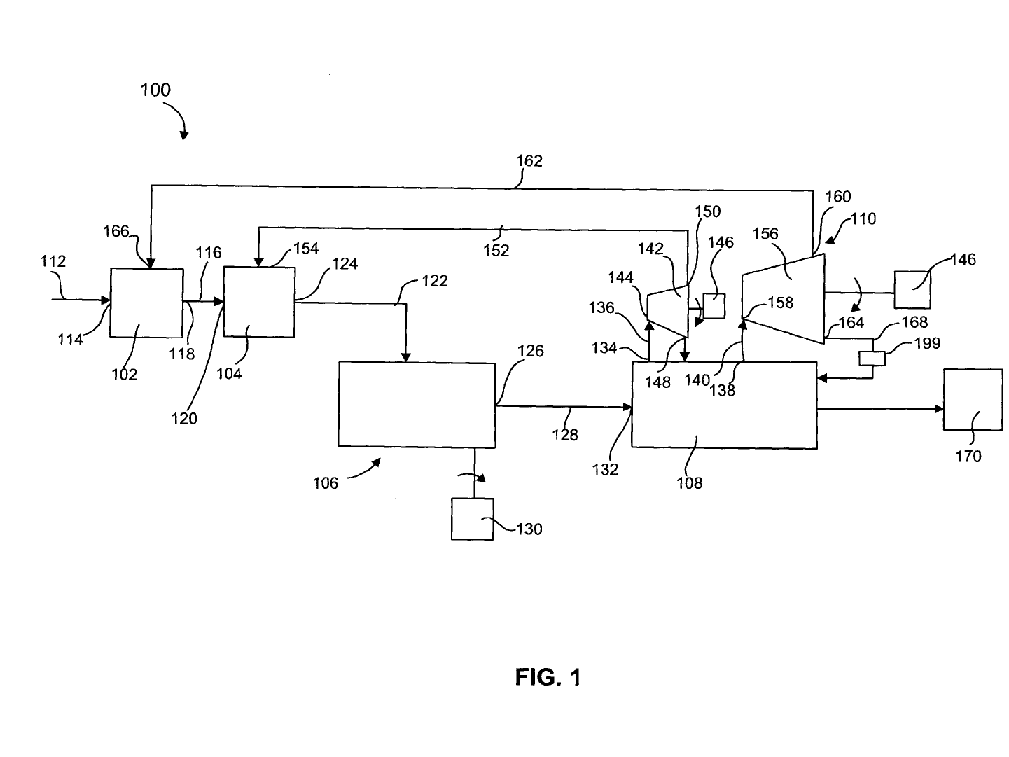

Referring to FIG. 1, an example of a methanol indirect combustion combined-cycle power generation apparatus 100 includes an evaporation apparatus 102, a conversion apparatus 104, a gas turbine assembly 106, a heat recovery steam generator (HRSG) 108, and a steam turbine assembly 110.

Liquid methanol is provided to the power generation apparatus from any suitable methanol source including, for example, a tank or pipeline (not shown) via a liquid methanol input stream 112. The liquid methanol may be pressurized to any desirable operating pressure. In the illustrated example, the liquid methanol is pressurized to a pressure of at least about 22 bar.

The liquid methanol input stream 112 is coupled to a liquid inlet 114 on the evaporation apparatus 102. The evaporation apparatus 102 can be any apparatus that is operable to heat the liquid methanol input stream 112 to evaporate the liquid methanol input stream 112 including, for example, the preheater and evaporator described below. Once evaporated, gaseous methanol can exit the evaporation apparatus 102 as a gaseous methanol stream 116, via a gas outlet 118.

The conversion apparatus 104 is connected downstream from the evaporation apparatus 102, and is configured to receive the gaseous methanol stream 116. In the illustrated example a gaseous methanol inlet 120 on the conversion apparatus 104 is coupled to the gas outlet 118 of the evaporation apparatus 102.

The conversion apparatus 104 can be any suitable apparatus that is operable to convert the gaseous methanol stream 116 into a syngas combustion stream 122 (including, for example, the decomposition reactor and steam reformer described below) which is suitable for combustion in the gas turbine assembly 106. The syngas combustion stream 122 exits the conversion apparatus via a combustion stream outlet 124.

The gas turbine assembly 106 is fluidly coupled to the conversion apparatus 104 downstream from the combustion stream outlet 124 to receive and burn the syngas combustion stream 122. The gas turbine assembly 106 has an exhaust outlet 126, through which hot exhaust gases can exit the gas turbine assembly 106, as an exhaust gas stream 128. The temperature of the exhaust gas stream 128 exiting the gas turbine assembly 106 can vary based on the operating conditions of any given gas turbine assembly, but can be in the range of, for example, between about 500 and about 650° C.

The gas turbine assembly 106 is also mechanically coupled to a first electric generator 130 such that the gas turbine assembly drives the electric generator to produce electrical power. The generator 130 can be any suitable electrical generator that is compatible with the gas turbine assembly 106.

The HRSG 108 recovers heat from the exhaust gas stream 128. In the illustrated example, the HRSG 108 includes an exhaust inlet 132 fluidly coupled to the exhaust outlet 126, which is configured to receive the exhaust gas stream 128 from the gas turbine assembly 106 and to use the heat from the exhaust gas stream 128 to generate steam. Steam from the HRSG 108 is used to drive the steam turbine assembly 110.

The HRSG 108 includes a first or high pressure steam outlet 134, for outputting relatively high temperature steam stream 136, and a second or intermediate pressure steam outlet 138, for outputting an intermediate steam stream 140. The high temperature steam stream 136 can have a temperature that is lower than the temperature of the exhaust gas stream 128, for example by about 20° C. to about 50° C., and in the example illustrated is about 550° C. The temperature of the intermediate steam stream 140 is lower than the temperature of the high temperature steam stream 136. Both the high temperature steam stream 136 and the intermediate temperature steam stream 140 are provided to the steam turbine assembly 110.

The steam turbine assembly 110 includes a first steam turbine 142 having a first steam inlet 144 fluidly coupled to the high pressure steam outlet 134 on the HRSG 108. The first steam turbine 142 can also be mechanically coupled to a compatible second electrical generator 146 to produce electrical power.

The first steam turbine 142 has a first exhaust outlet 148 and a first extraction outlet 150 for extracting a first extracted steam stream 152 from the first steam turbine 142. The first extraction outlet 150 is fluidly coupled to a first steam inlet 154 on the conversion apparatus 104 to route the first extracted steam stream 152 to the conversion apparatus 104. The heat provided to the conversion apparatus 104 via the first extracted steam stream 152 is used to provide the thermal energy used in the conversion process (e.g. to convert methanol to syngas). Preferably, the heat supplied by the first extracted steam stream 152 is sufficient to facilitate conversion of the gaseous methanol stream 116 into the syngas combustion stream 122 without the need for supplying additional heat from another source (such as a boiler, etc.).

In the illustrated example, the first extracted steam stream 152 includes a portion of the quantity of steam that is provided to the first steam turbine 142 from via the high temperature steam stream 136. Optionally, the first extracted steam stream 152 can include between about 10% and about 70% of the steam provided to the first steam turbine 142. In some instances, the first extracted steam stream 152 can include about 50% to about 60% of the steam provided to the first steam turbine 142 depending on the gas turbine model selected, the methanol reactor design and the steam cycle arrangement. The first extracted steam stream 152 is at a lower temperature than the high temperature steam stream 136, and at a higher temperature than the operating temperature of the conversion apparatus 104.

The remaining steam passing through the first steam turbine 142 (i.e. steam not extracted via the first extraction outlet 150) exits the first steam turbine 142 as exhaust steam, via the first exhaust outlet 148. In the illustrated example, the exhaust steam is re-introduced in the HRSG 108, re-heated and then directed to the second steam outlet 138.

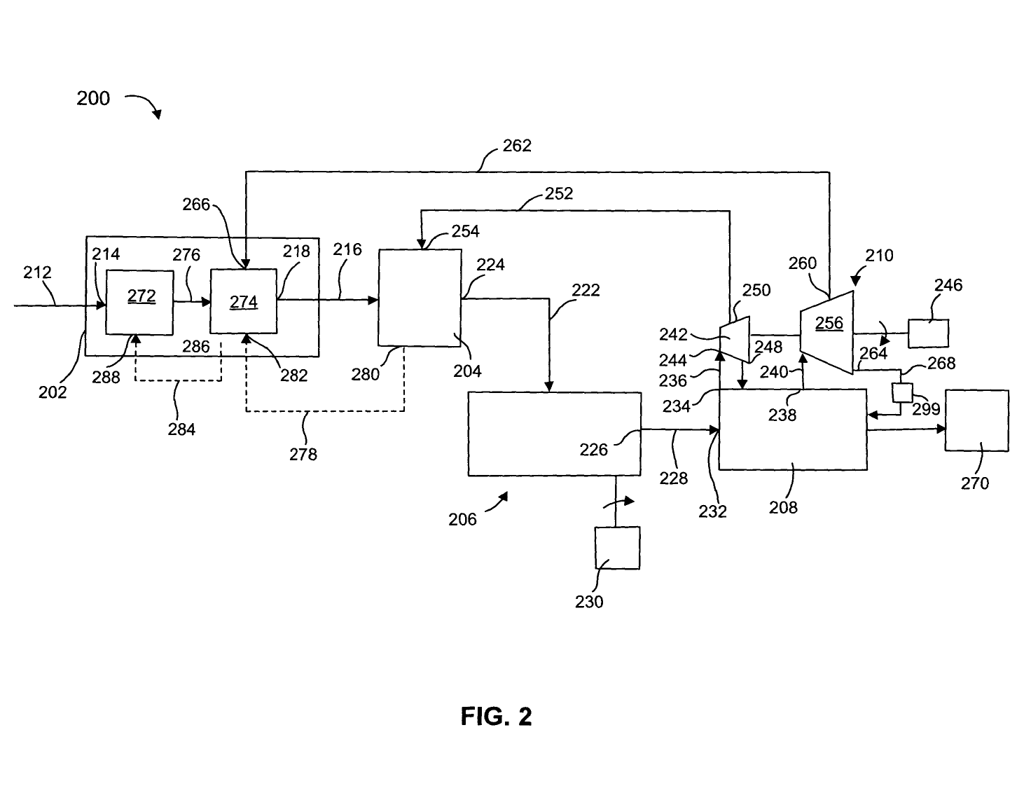

The steam turbine assembly 110 also includes a second steam turbine 156 having a second steam inlet 158 that is fluidly coupled to the second steam outlet 138 on the HRSG 108. The second steam turbine 156 is also mechanically connected to a second generator 146 (optionally the same generator that is connected to the first steam turbine 142, see FIG. 2) to produce electrical power.

The second steam turbine 156 includes a second extraction outlet 160 for extracting a second extracted steam stream 162 from the second steam turbine 156, and a second exhaust outlet 164. The second extraction outlet 160 is fluidly coupled to a second steam inlet 166 on the evaporation apparatus 102 to route the second extracted steam stream 162 to the evaporation apparatus 102. Heat from the second extracted steam stream 162 is used to evaporate the liquid methanol passing through the evaporation apparatus 102. Optionally, the heat provided to the evaporation apparatus 102 via the second extracted steam stream 162 can be sufficient to evaporate the liquid methanol input stream 112 without the need for an additional heat source.

The second extracted steam stream 162 includes only a portion of the steam passing through the second steam turbine 158. Preferably, the quantity of steam in the second extracted steam stream 162 is less than the quantity of steam in the first extracted steam stream 152. In the illustrated example, the second extracted steam stream 162 can include between about 5% and about 30%, or between about 10% and about 20% of the quantity of steam provided to the second steam turbine 156 (i.e. the steam in the intermediate temperature steam stream 140).

The second extracted steam stream 162 is at a temperature that is lower than the first extracted steam stream 152, and optionally, higher than the operating temperature of the evaporation apparatus 102 (i.e. higher than the boiling temperature of the liquid methanol input stream 112).

Steam exhausted from the second steam turbine 156, via the second exhaust outlet 164, returns to the HRSG 108 via a second exhaust stream 168. The exhaust stream of the gas turbine can then be channeled to any suitable disposal or treatment apparatus 170 including, for example, being ejected from a stack as flue gas. Optionally, additional processing equipment (including, for example, a condenser) can be positioned in the second exhaust stream 168. The use of such additional processing equipment may further increase the efficiency of the power generation apparatus.

In the illustrated example, two different extracted steam streams 152 and 162 are coupled to two different upstream locations (the conversion apparatus 104 and the evaporation apparatus 102, respectively). Using waste heat recovered from a downstream location in the power generation apparatus 100 to provide the required heat to perform processes upstream in the power generation apparatus 100 may help improve the efficiency of the power generation apparatus 100 (measured as the amount of electrical power generated per unit of liquid methanol consumed).

Referring to FIG. 2, another example of a power generation apparatus 200 includes an evaporation apparatus 202, a conversion apparatus 204, a gas turbine assembly 206, a heat recovery steam generator (HRSG) 208, and a steam turbine assembly 210. The power generation apparatus 200 is similar to the power generation apparatus 100, and other like elements are also identified using like references numerals beginning at 200.

As explained in detail above, heat for the conversion apparatus 204 is provided by the first extracted steam stream 252 that is taken from the first steam turbine 242. The heat provided by the first extracted steam stream 252 is adequate to facilitate operation of the conversion apparatus 204 without the introduction of additional heat.

In this example, the evaporation apparatus 202 includes a preheater 272 (which may be any suitable apparatus, including, for example a heat exchanger), for receiving and pre-heating the liquid methanol input stream 212, and an evaporator 274 connected downstream from the preheater 272. The liquid methanol 112 exits the preheater 272 as a preheated methanol stream 276 and then flows into the evaporator 274. The evaporator 274 further heats the preheated methanol stream 276 until the liquid methanol boils, to provide the gaseous methanol stream 216. In the illustrated example, the heat for the evaporator 274 is provided by steam 262 extracted from the second steam turbine 256, and the evaporator 274 comprises the second steam inlet 266 for receiving the second extracted steam stream 262.

Optionally, the evaporation apparatus 202 can be configured so that all of the heat required for the evaporator 274 is provided by the second extracted steam stream 262. Alternatively, some or all of the condensate exiting the conversion apparatus 204 (having been used to provide heat to facilitate the conversion process) can be re-introduced into the evaporation apparatus 202 to provide an additional source of heat. Alternatively, or in addition, some or all of the condensate exiting the conversion apparatus 204 (and/or the evaporation apparatus as described below) can be re-introduced into another part of the power generation apparatus 200 including, for example, to pre-heat water entering the HRSG 208.

In the illustrated example, an optional (as indicated by the use of dashed lines) first recycle condensate stream 278 allows some or all condensate exiting the conversion apparatus 204 to be introduced into the evaporator 274. In this example, a first recycle condensate outlet 280 on the conversion apparatus 204 is coupled to a first recycle condensate inlet 282 on the evaporation apparatus 202 to transfer the first recycle condensate stream 278 from the conversion apparatus 204 to the evaporator 274, to provide additional heat to the evaporator 274 (in addition to the heat supplied via the second extracted steam stream 262).

The first recycle condensate stream 278 is at a first recycle temperature that is hotter than an operating temperature of the evaporator 274 (i.e. hotter than the boiling point of the liquid methanol stream).

Optionally, the evaporation apparatus 202 can also include a second recycle condensate stream 284 that can transfer condensate exiting the evaporator 274 to the preheater 272. In this example, a second recycle condensate outlet 286 on the evaporator 274 is coupled to a second recycle condensate inlet 288 on the preheater 272 to transfer the second recycle condensate stream 284 from the evaporator 274 to the preheater 272 to provide heat to pre-heat the liquid methanol input stream 212. In the illustrated example, the second recycle condensate stream 284 provides substantially all of the heat used in the preheater 272.

Optionally, a portion of the second extracted steam stream 262 may be provided directly to the preheater 272.

In this example, both steam turbines 242 and 256 are mechanically coupled to the same second electrical generator 246.

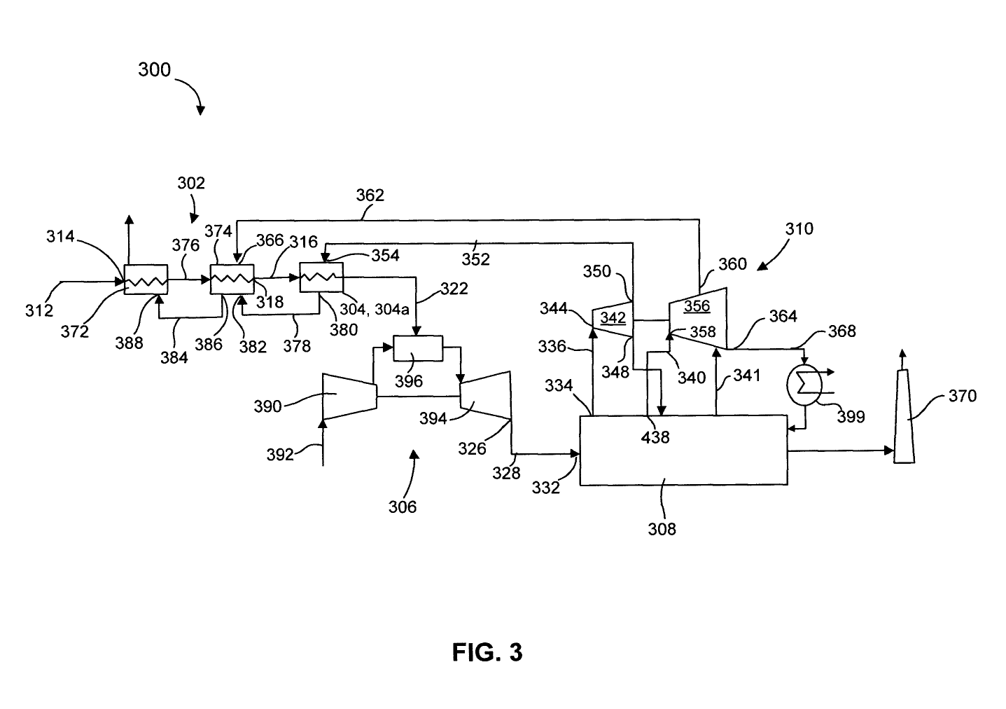

Referring to FIG. 3, another example of a power generation apparatus 300 includes an evaporation apparatus 302, a conversion apparatus 304, a gas turbine assembly 306, a heat recovery steam generator (HRSG) 308, and a steam turbine assembly 310. The power generation apparatus 300 is similar to the power generation apparatuses 100 and 200, and other like elements are similarly identified using like references numerals beginning at 300.

In this example, the conversion apparatus 304 includes a decomposition reactor 304a (of any suitable configuration) that is operable to convert the gaseous methanol stream 316 into a syngas combustion stream 322 that includes hydrogen and carbon monoxide. The syngas combustion stream 322 is then fed into the gas turbine assembly 306. Optionally, the syngas combustion stream 322 is fed into the gas turbine assembly 306 without separating the hydrogen from the carbon monoxide.

In this example, the gas turbine assembly 306 is a typical gas turbine assembly 306 including a compressor 390, receiving a supply of air 392, a gas turbine 394 and a combustor 396 coupled therebetween. The syngas combustion stream 322 is introduced into the combustor 396 for combustion. The steam turbine assembly can also include a low pressure steam line 341 carrying steam that is generated from the HRSG and inducted to the second steam turbine.

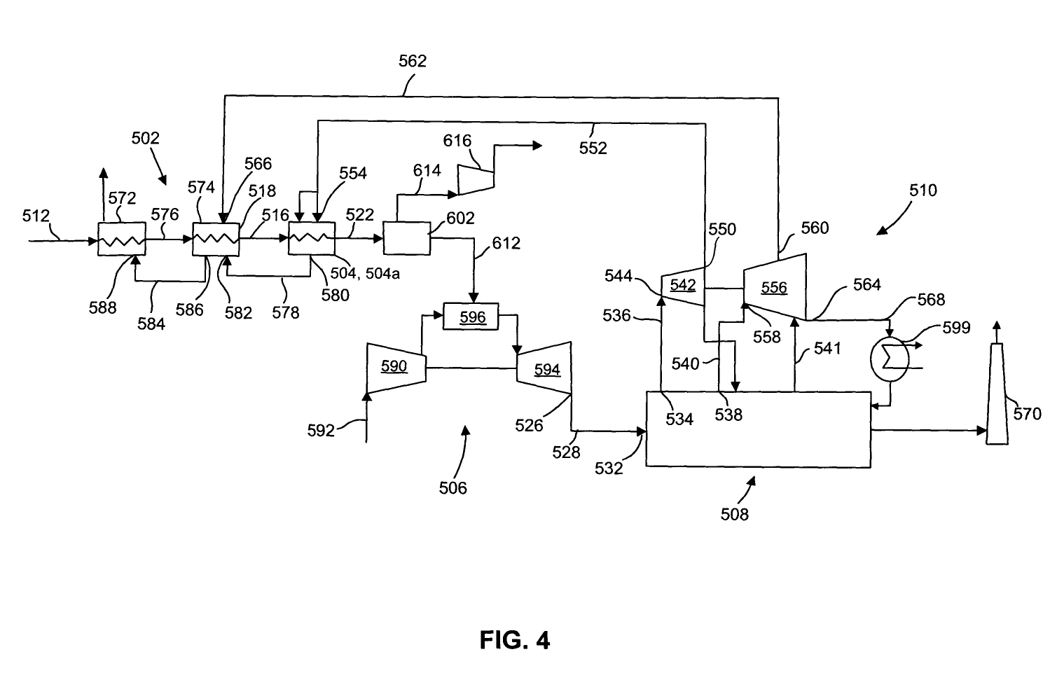

Referring to FIG. 4, another example of a power generation apparatus 500 includes an evaporation apparatus 502, a conversion apparatus 504, a gas turbine assembly 506, a heat recovery steam generator (HRSG) 508, and a steam turbine assembly 510. The power generation apparatus 500 is similar to the power generation apparatuses 100, 200, and 300, and other like elements are similarly identified using like references numerals beginning at 500.

In this example, the conversion apparatus 504 includes a steam reformer 504a (of any suitable configuration). The steam reformer 504a is operable to produce a syngas combustion stream 522 including hydrogen and carbon dioxide.

Optionally, the syngas combustion stream 522 can be provided directly to the gas turbine assembly 506, without removing the carbon dioxide. However, in some instances it may be desirable to separate some or all of the carbon dioxide from the hydrogen contained in the syngas combustion stream 522 prior to introducing the syngas combustion stream 522 into the gas turbine assembly 506. In such instances, as illustrated, the power generation apparatus 500 can also include a separator apparatus 602 that is fluidly connected between the steam reformer 504a and the gas turbine assembly 506.

The separator apparatus 602 can be any apparatus that is operable to separate carbon dioxide from the syngas combustion stream 522 prior to introducing the syngas combustion stream 522 to the gas turbine assembly 506 including, for example, a physical absorption carbon dioxide separator.

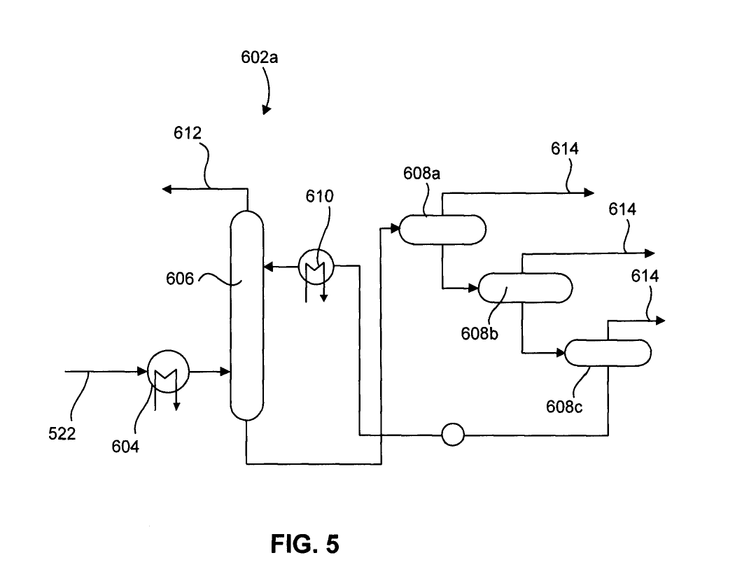

Referring to FIG. 5, one example of a suitable physical absorption separator apparatus is a Selexol™ carbon capture system 602a, manufactured by UOP LLC. In the Selexol™ system the incoming syngas combustion stream 522 is cooled, via a gas cooler 604, and goes into a CO₂ absorber 606 where lean solvent absorbs the carbon dioxide from the syngas combustion stream 522 and hydrogen is drawn off from the top of the absorber. The solvent, now rich with carbon dioxide, is let down through three flash tanks 608a-c to release the entrained carbon dioxide, which is drawn off via carbon dioxide streams. Lean solvent collected at the bottom of the flash tanks 608a-c is cooled, via solvent cooler 610, and pumped back into the CO₂ absorber 604.

Referring as well to FIG. 4, the hydrogen gas stream 612 drawn off from the CO₂ absorber 606 is routed to the gas turbine assembly 506. The carbon dioxide streams 614 collected from the flash tanks 608a-c can be compressed, via compressor 616, and sent for further processing or sequestration.

In the illustrated examples, condensers 199, 299, 399 and 599 are provided in the second exhaust streams 168, 268, 368 and 568, between the second steam turbines 156, 256, 356, and 556 the HRSGs 108, 208, 308 and 508, respectively. Optionally, the operating pressure at the second exhaust outlets 134, 264, 364 and 564 can be below ambient pressure (i.e. under vacuum conditions). Operating with the second exhaust outlets under vacuum conditions may help increase the overall efficiency of the power generation apparatuses 100, 200, 300 and 500.

While each of the examples above are illustrated as including two steam turbines (e.g. 142 and 156), more than two steam turbines could be provided. Alternatively, or in addition, some or all of the steam turbines could be multi-stage turbines.

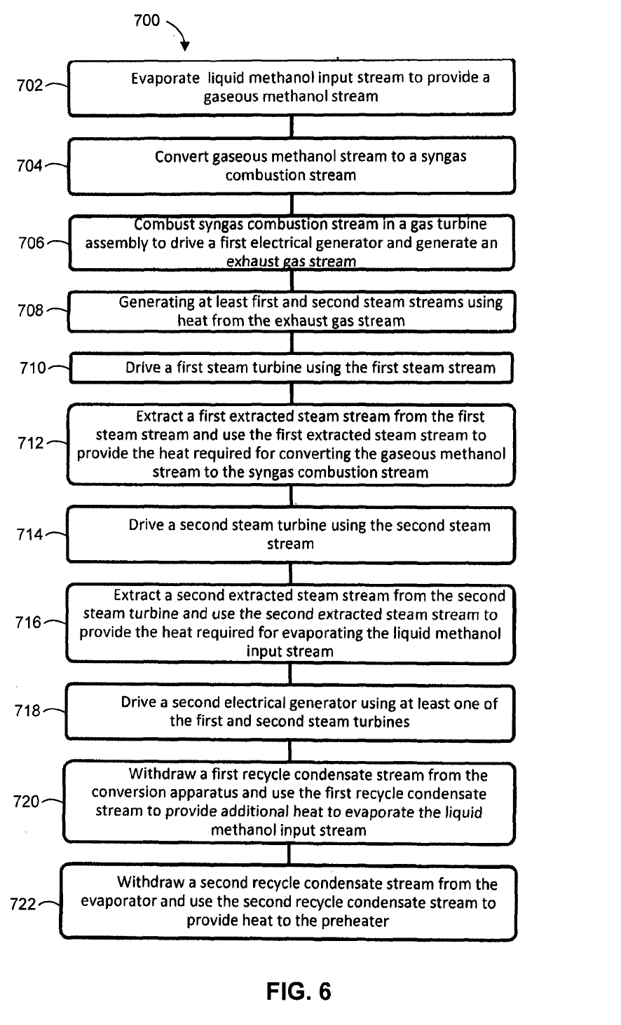

Referring to FIG. 6, a method 700 of operating the power generation apparatuses 100, 200, 300 and/or 500 includes the general steps of 702 evaporating a liquid methanol input stream to provide a gaseous methanol stream; 704 converting the gaseous methanol stream to a syngas combustion stream; 706 combusting the syngas combustion stream in a gas turbine assembly to drive a first electrical generator and generate an exhaust gas stream; 708 generating at least first and second steam streams using heat from the exhaust gas stream; 710 driving a first steam turbine using the first steam stream; 712 extracting a first extracted steam stream from the first steam stream and using the first extracted steam stream to provide the heat required for converting the gaseous methanol stream to the syngas combustion stream; 714 driving a second steam turbine using the second steam stream; 716 extracting a second extracted steam stream from the second steam turbine and using the second extracted steam stream to provide the heat required for evaporating the liquid methanol input stream; and 718 driving a second electrical generator using at least one of the first and second steam turbines.

The method can also include the optional step 720 of withdrawing a first recycle condensate stream from the conversion apparatus and using the first recycle condensate stream to provide additional heat to evaporate the liquid methanol input stream.

Optionally, step 702 can include passing the liquid methanol input stream through both a preheater and an evaporator, and the second extracted steam stream can provide heat to the evaporator.

The method can also include the optional step 722 of withdrawing a second recycle condensate stream from the evaporator and using the second recycle condensate stream to provide heat to the preheater.

Optionally, for example when operating power generation apparatus 300, step 704 can include processing the gaseous methanol stream in a decomposition reactor 304a so that the syngas combustion stream 322 comprises hydrogen and carbon monoxide.

Alternatively, for example when operating power generation apparatus 500, step 704 can include processing the gaseous methanol stream in a reformer 504a so that the syngas combustion stream 522 comprises hydrogen and carbon dioxide.

In such an instance, the method can also include the optional step 726 of separating at least a portion of the carbon dioxide from the syngas combustion stream prior to combusting the syngas combustion stream in the gas turbine assembly. Optionally, some or all of the carbon dioxide can be separated from the syngas combustion stream in step 726 using a physical absorption carbon dioxide separator.

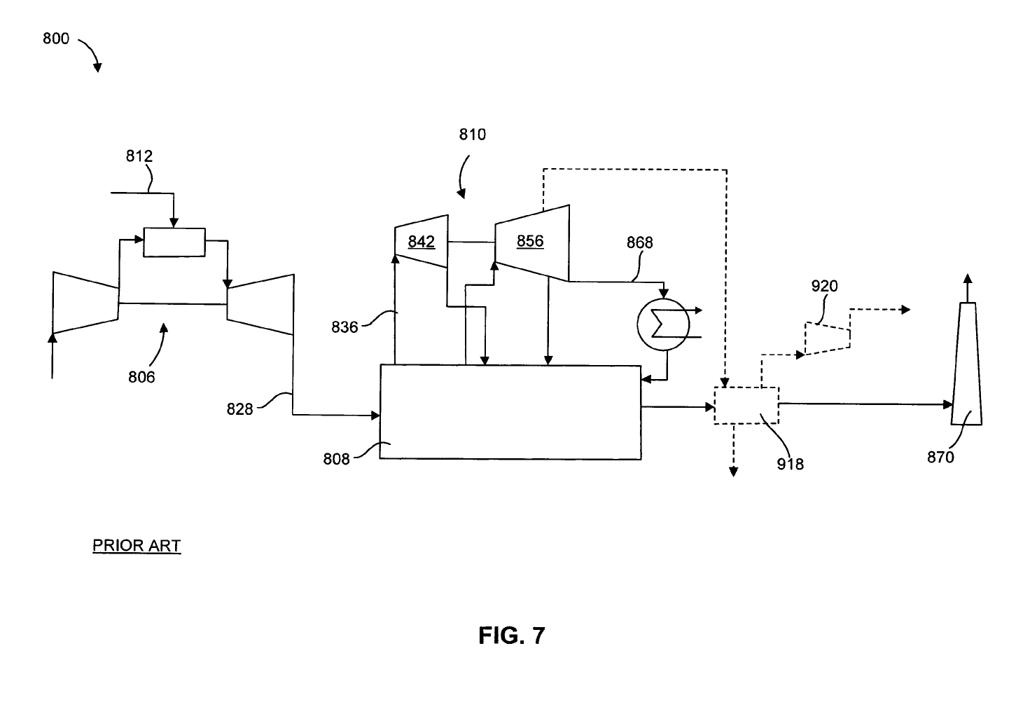

The power generation apparatuses 100, 200, 300 and 500 described above may be more efficient than other combined cycle, methanol fueled power generation apparatuses known in the art (i.e. they may be able to generate more electrical power given the same methanol feedstock). To investigate this, computer simulations were conducted, using Aspen Plus™ and GTPro™ modeling software, and exergy analysis to compare the performance of power generation apparatuses 100, 200, 300 and 500 to two conventional methanol fueled combined cycle systems 800, illustrated in FIG. 7. The conventional system 800 illustrated for comparative purposes includes some of the same components as apparatuses 100, 200, 300 and 500, and like components will be identified using like reference numerals beginning at 800.

Referring to FIG. 7, an example of a known methanol fueled power generation system 800 includes a gas turbine assembly 806 that is directly fueled by a methanol input stream 812. The hot exhaust 828 from the gas turbine assembly 806 is used to generate steam in a HRSG 808, and steam from the HRSG 808 is used to drive two steam turbines 842, 856 in steam turbine assembly 810. This known system 800 does not include an evaporation apparatus or a conversion apparatus, and does not extract steam from the steam turbine assembly 810 to pre-heat or otherwise treat the incoming methanol stream 812.

The conventional system 800 was modeled in two variations, one of which included an optional post-combustion (i.e. downstream from the gas turbine assembly) carbon dioxide capture apparatus 918, as indicated using dashed lines. The carbon dioxide capture apparatus 918 includes a conventional monoethanolamine (MEA) unit for extracting carbon dioxide from the outlet of HRSG 808, and can include a compressor 920 for compressing the carbon dioxide for further processing and/or sequestration.

Four cases in were modeled and investigated.
Case 1: Conventional apparatus 800 variant one—a conventional combined cycle based on methanol direct combustion, without CO₂ capture;
Case 2: New apparatus 300—a combined cycle based on methanol decomposition, without CO₂ capture;
Case 3: Conventional apparatus 800 variant two—a conventional combined cycle based on methanol direct combustion, with post-combustion CO₂ capture 918; and
Case 4: New apparatus 500—a combined cycle based on methanol steam reforming, with pre-combustion CO₂ capture.

In each of the simulations, the liquid methanol input was supplied at a pressure greater than 22 bar and evaporated to a gaseous methanol stream having a temperature of about 200° C. to about 220° C., which is also the approximate temperature of the conversion process. While the illustrative examples described above have used methanol as the initial feedstock, other suitable hydrocarbon feedstocks may be used in place of methanol, including, for example, methane and ethanol.

As explained in detail above, in apparatus 300 and 500 the sources for methanol conversion (decomposition 304a or reformation 504a) and heating/evaporation were modeled as the first extracted steam stream (e.g. 352, 552 drawn from the first steam turbine) and the second extracted steam stream (e.g. 362, 562 drawn from the second steam turbine).

In apparatus 300 the heat of condensation of first extracted steam stream 352 is mainly used to sustain the endothermic conversion apparatus (e.g. the reaction of methanol decomposition 304a) and the heat of condensation of second extracted steam stream 362 is used to evaporate methanol, which happens at around 169° C. The condensates from both first and second extracted steam streams 352, 362 were further utilized to preheat methanol liquid in the preheater 372 (i.e. via the recycle condensate streams 378, 384).

In the model generated, the combined cycle apparatuses 300 and 500 include a gas turbine, HRSG and steam turbine generator, as explained in detail above. The simulated steam bottoming cycle has three pressure levels (e.g. steam entering the first turbine, steam entering the second turbine and steam inducted to the second turbine) and reheating, and the cooling system includes a condenser (e.g. 399, 599) and a mechanical draft cooling tower. Differences from a conventional combined cycle configuration 800 include the use of gas turbines 306 that burn syngas (as opposed to methanol) and the use of steam turbines 342, 356 with two stages of extraction steam 352, 362.

AspenPlus™ was used to model methanol fuel heating and decomposition as well as syngas fueled gas turbine. GTPro™ was used to model steam bottoming cycle (including a HRSG, steam turbine and cooling system) and CO₂ capture and compression process (if applicable). The interfaces between the two models are gas turbine exhaust, IP and LP steam, and condensates. The interfaces are matched to help facilitate simulation accuracy.

In the simulation, an F-class gas turbine was selected with a turbine rotor inlet temperature (TIT) of 1327° C. A simplified turbine cooling model was adopted for simulating the gas turbine. The methanol property was calculated with AspenPlus™ and the higher heating value (HHV) is 22.7 MJ/kg. ISO ambient conditions were used which are 1.013 bar, dry bulb temperature 15° C., and relative humidity 60%. The major assumed parameters are listed in Table 1.

TABLE 1
Main Assumptions for Combined Cycle Cases

| | | |
|---|---|---|
| ΔTₚₚ of methanol heater | ° C. | 10 |
| ΔT of methanol reactor^{a} | ° C. | 10/19 |
| GT compressor air flow | t/h | 1530 |
| rate | | |
| GT compression ratio | | 15.5 |
| GT compressor | % | 89 |
| efficiency | | |
| GT turbine efficiency | ° C. | 91 |
| ΔTₚₚ of HRSG | ° C. | 10 |
| ΔTₐₚᵣ of HRSG | ° C. | 10 |
| HRSG blowdown ratio | % | 1 |
| Main steam pressure | bar | 124 |
| Main steam temperature/ | ° C. | 550 |
| hot reheat temperature | | |
| Condenser pressure | kPa | 5.0 |
| IP process steam | bar | 28.9/23.0 |
| pressure^{a} | | |
| LP process steam | bar | 10.0/10.3 |
| pressure^{a} | | |

^{a}values are for Case 2/Case 4

The performance results of the methanol indirect combustion combined cycle apparatus 300 are summarized in Case 2 of Table 2. The results indicate that net plant efficiency may reach as high as 53.3% HHV while the net output is 242.8 MW.

TABLE 2
Performance Data of Combined Cycle Cases

| | | | Case 2 | Case 3 | |
|---|---|---|---|---|---|
| | | Case 1 | Methanol | Conventional | Case 4 |
| | | Conventional | decomp. | Post-comb. | Methanol reforming |
| | | No capture | No capture | capture | Pre-comb. capture |
| Methanol flow rate | t/h | 86.4 | 67.7 | 86.4 | 71.4 |
| Fuel heat input, HHV | MWth | 543.7 | 426.3 | 543.7 | 449.2 |
| GT output | MW | 186.8 | 179.9 | 186.8 | 181.4 |
| ST output | MW | 90.9 | 58.8 | 68.4 | 57.3 |
| Total gross output | MW | 277.7 | 238.6 | 255.2 | 238.8 |
| Total auxiliary load^{a} | MW | 6.1 | 5.3 | 23.4 | 15.3 |
| Total net output | MW | 271.7 | 233.3 | 231.8 | 223.5 |
| CO₂ captured | t/h | | | 100.8 | 88.2 |
| Net efficiency, HHV | % | 49.97 | 54.73 | 42.63 | 49.75 |

| | | | |
|---|---|---|---|
| Efficiency Improvement | % points | 4.76 | 7.12 |

^{a}Total auxiliary load includes parasitic load of CO₂ capture and compression; parasitic load for CO₂ compression is 9.3 MW and 7.8 MW for Case 3 and Case 4 respectively

For comparison reasons, the conventional combined cycle 800 based on methanol direct combustion was also modeled. FIG. 7 shows its flow schematic (by solid lines). The configuration is the same as a conventional natural gas fired combined cycle except that liquid methanol fuel is used. This system 800 was modeled based on the same assumed parameters and methodology as above, and the results are presented in Case 1 of Table 2. It has net plant efficiency and net output of 48.7% HHV and 284.4 MW respectively.

In comparison, combined cycle efficiency is improved by 4.5% points through methanol indirect combustion.

The net output of Case 2 is less than Case 1 by 14.6% (242.8 MW vs. 284.4 MW). This may be due to two extracted steam streams being taken from the steam cycle for methanol heating and decomposition, which may lead to lower steam turbine output for Case 2 although both cases have a similar gas turbine output. However, it is also noted that fuel input of Case 2 is lower than Case 1 by 21.9% (72.4 t/h vs. 92.7 t/h).

The simulation indicates that the efficiency of Case 2 (apparatus 300) is 4.5% higher than Case 1 (apparatus 800). To further analyze the performance difference, if any, between the two cases, an exergy analysis was also carried out.

The exergy concept is based on both the first and second laws of thermodynamics. One reason for using exergy analysis is to detect and evaluate quantitatively the losses that occur in thermal and chemical processes. Exergy can be understood as the maximum amount of work that can be obtained from a material stream, heat stream or work interaction by bringing this stream to environmental conditions. Three forms of exergy contribute to total exergy: thermal exergy, chemical exergy and work. The reference point of the thermal exergy calculation was 1.013 bar and 25° C.

Table 3 shows a comparison of distribution of exergy destruction of Case 1 and Case 2. As can be seen, the largest process irreversibility takes place in the gas turbine assembly combustor because fuel combustion degrades available energy significantly. Because of methanol indirect combustion, the exergy destruction in the gas turbine assembly combustor for Case 2 is lower than Case 1 (24.4% vs. 32.4%).

The exergy destruction percentage of gas turbine assembly compressor and turbine for Case 2 is higher than Case 1 (8.3% vs. 6.5%). The reason may be that Case 2 has less methanol fuel consumption than Case 1 leading to lower exergy input to the system, but both cases have similar duties for the gas turbine assembly compressor and turbine and generally equivalent amounts of exergy destruction. For the same reason, the exergy destruction percentage of HRSG 308 for Case 2 is higher than Case 1.

The steam turbine assembly 310 for Case 2 has a lower output due to the extracted steam streams. It also has less output and less exergy destruction than Case 1.

TABLE 3
Exergy Destruction Comparison among Four Cases

| Case 1 | | Case 2 | | Case 3 | | Case 4 | |
|---|---|---|---|---|---|---|---|
| Conventional | | Methanol decomp. | | Conventional | | Methanol reforming | |
| No capture | | No capture | | Post-comb. capture | | Pre-comb. capture | |
| | Ratio of | | Ratio of | | Ratio of | | Ratio of |
| | Exergy | | Exergy | | Exergy | | Exergy |
| | to Total | | to Total | | to Total | | to Total |
| Exergy | Exergy | Exergy | Exergy | Exergy | Exergy | Exergy | Exergy |
| (MW) | (%) | (MW) | (%) | (MW) | (%) | (MW) | (%) |

Total Exergy

| | | | | | | | | |
|---|---|---|---|---|---|---|---|---|
| Fuel exergy | 537.8 | 100.0 | 421.8 | 100.0 | 537.8 | 100.0 | 444.3 | 100.0 |

Exergy Destruction

| | | | | | | | | |
|---|---|---|---|---|---|---|---|---|
| Methanol heating | | | 4.2 | 1.0 | | | 3.9 | 0.9 |
| Methanol | | | 2.2 | 0.5 | | | 13.8 | 3.1 |
| decomposition/reforming | | | | | | | | |
| GT combustor | 175.4 | 32.6 | 103.9 | 24.6 | 175.4 | 32.6 | 109.9 | 24.7 |
| GT compressor and | 30.1 | 5.6 | 29.8 | 7.1 | 30.1 | 5.6 | 29.9 | 6.7 |
| turbine | | | | | | | | |
| HRSG | 19.1 | 3.6 | 18.0 | 4.3 | 20.5 | 3.8 | 17.2 | 3.9 |
| Steam turbine and | 16.5 | 3.1 | 10.2 | 2.4 | 9.9 | 1.8 | 9.5 | 2.1 |
| condenser | | | | | | | | |
| Exhaust loss | 19.0 | 3.5 | 14.9 | 3.5 | 19.0 | 3.5 | 15.7 | 3.5 |
| CO₂ capture and | | | | | 45.3 | 8.4 | 15.8 | 3.6 |
| compression | | | | | | | | |
| Auxiliary load ^{a} | 6.1 | 1.1 | 5.3 | 1.3 | 5.8 | 1.1 | 5.1 | 1.1 |

Exergy Output

| | | | | | | | | |
|---|---|---|---|---|---|---|---|---|
| Power | 271.7 | 50.5 | 233.3 | 55.3 | 231.8 | 43.1 | 223.5 | 50.3 |

Total Sum

| | | | | | | | |
|---|---|---|---|---|---|---|---|
| 537.8 | 100.0 | 421.8 | 100.0 | 537.8 | 100.0 | 444.3 | 100.0 |

^{a} Auxiliary load does not include parasitic load of CO₂ capture and compression

Exergy analysis shows that the exergy destruction of gas turbine assembly combustor 396 of Case 2 is lower than Case 1 by 8%. This can be reasonably explained by a principle of cascade utilization with a combination of chemical exergy and physical exergy.

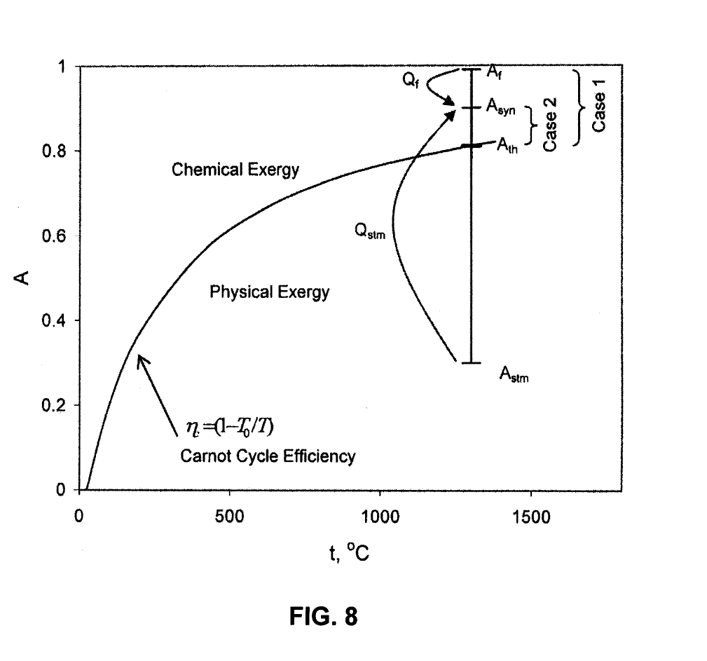

In FIG. 8, the A-t co-ordinates represent energy level and temperature respectively. The area above the Carnot efficiency curve (η_{C}) illustrates chemical exergy, while the area below shows physical exergy. The cascade utilization of physical exergy is achieved by integrating Brayton cycle and Rankine cycle based on the thermal energy levels. As for the chemical exergy of hydrocarbon fuels in combustion, their energy levels (A_{f}) could be as high as about 1.0, while the energy level of hydrogen-rich syngas fuel (A_{syn}) has a value between 0.83 and 0.9. As a result, it is possible to effectively utilize the chemical exergy of fuels with different energy levels, similar to the cascade utilization of physical energy in power cycle.

Chemical exergy of hydrocarbon fuels is traditionally released through direct combustion and is utilized as a form of thermal exergy. Consequently, the higher energy level of hydrocarbon fuels A_{f} is degraded to the energy level of thermal energy Aₜₕ, resulting in greater exergy destruction in fuel combustion, (A_{f}-Aₜₕ) as for Case 1.

Alternatively, the chemical exergy difference between A_{f} and A_{syn} is used to convert the methanol fuel to syngas first, followed by syngas combustion (methanol indirect combustion) where the chemical exergy A_{syn} is released to the thermal energy level of Aₜₕ. The energy level degradation from chemical energy to thermal energy is reduced, (A_{syn}-Aₜₕ) as for Case 2.

According to FIG. 8, it is also noted that both fuel energy Q_{f} and steam energy Qₛₜₘ are added to the gas turbine assembly combustor 396 for Case 2. Due to cascade utilization of fuel chemical exergy, the steam energy of Qₛₜₘ at lower grade Aₛₜₘ is upgraded to the higher energy level A_{syn}. The ratio of Qₛₜₘ to Q_{f} is about 20% for Case 2, which leads to reduction of fuel consumption resulting in significant efficiency improvement.

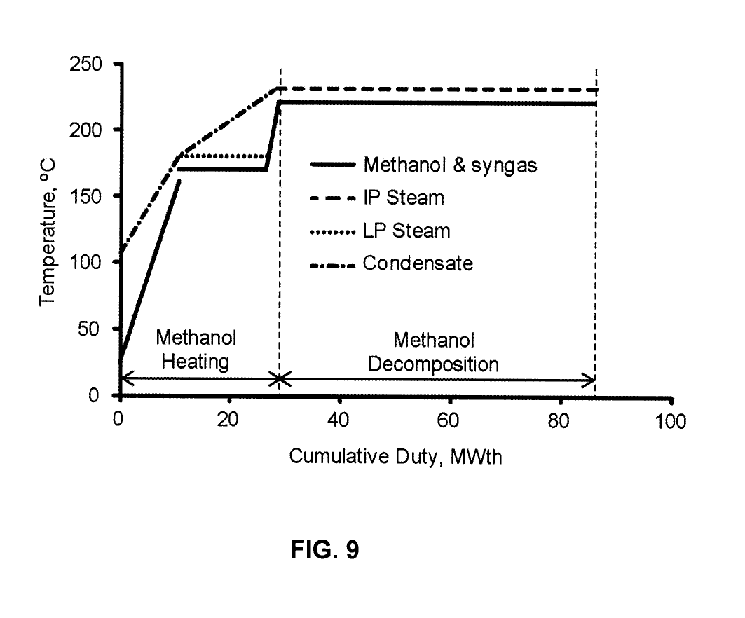

In Case 2, two extracted steam streams 352, 362 are used for methanol heating and conversion. The heat transfer profile of Case 2 is shown in FIG. 9.

In FIG. 9, the majority of heat duty (about 67%) is for the methanol decomposition reactor 304a. The heat source is the first extracted steam stream 352. Because of the constant temperature of both sides (two parallel lines), the overall heat transfer temperature difference is only about 10° C. As a result, the exergy destruction of methanol decomposition for Case 2 in Table 3 may be as low as 0.5%.

To help reduce the first extracted steam stream 352 consumption (which may help increase overall efficiency), the separate, second extracted steam stream 362 is used for methanol evaporation. This may help increase efficiency due to the heat transfer between two parallel lines. Condensate can also effectively be utilized, via the recycle condensate streams. In this configuration, the exergy loss of methanol heating may be only about 1%.

Referring to FIG. 4, the flow schematic of the apparatus illustrates a pre-combustion CO₂ capture combined cycle based on methanol fuel (apparatus 500). Similar to Case 2, the liquid methanol for this simulation was at a pressure of over 22 bar and was heated and converted into gas through 3 stages (preheating, evaporation and superheating). The methanol gas is heated to a temperature of about 200° C., and then mixed with first extracted steam stream 552 and reacted at the steam reforming rector 504a.

In this model, methanol and steam react at the steam reformer 504a producing H₂ and CO₂ as per Equation 2. CO₂ is then separated through a physical CO₂ separator 602 (e.g. Selexol apparatus—see FIG. 5) as the gas is pressurized. The separated CO₂ can be compressed to 138 bar for subsequent sequestration. The H₂ is fed to the gas turbine assembly 506 as fuel. The modeling parameters of the Selexol unit are listed in Table 4.

TABLE 4
Assumptions for Selexol and MEA Apparatus

| Flash tank stage | | |
|---|---|---|
| 1 | 2 | 3 |

Selexol unit:

| | | | | |
|---|---|---|---|---|
| Flash pressure/inlet gas | | 0.850 | 0.500 | 0.075 |
| CO₂ partial pressure | | | | |
| CO₂ production/total CO₂ | % | 40 | 25 | 35 |

| | | |
|---|---|---|
| CO₂ capture efficiency | % | 90 |

MEA unit:

| | | |
|---|---|---|
| Specific heat duty of reboiler | GJth/t CO2 | 3.32 |
| LP steam pressure | bar | 3.05 |
| CO₂ capture efficiency | % | 85 |

The performance results of the combined cycle apparatus 500 are presented in Case 4 of Table 2. The net plant efficiency and net output are 48.5% HHV and 232.0 MW respectively. Because of CO₂ capture, both output and efficiency of Case 4 are lower than Case 2.

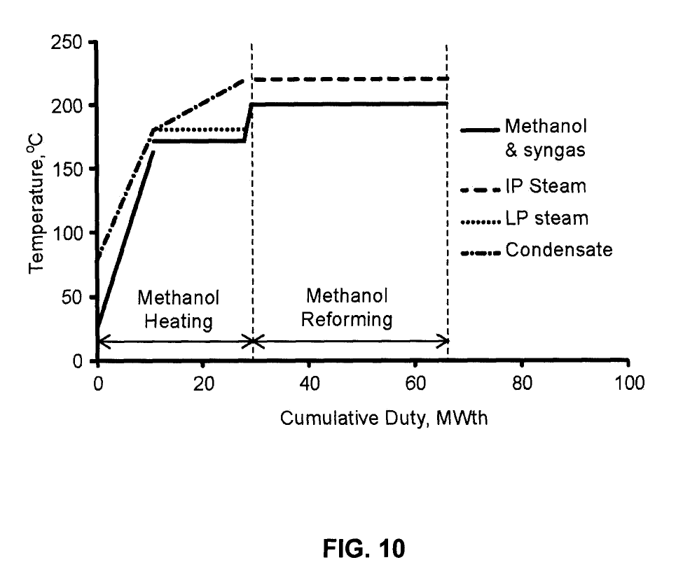

The heat transfer profile of Case 4 is shown in FIG. 10. Similar to Case 2, heat transfer in both methanol evaporator and steam reformer happens between two parallel lines, and extracted steam stream condensates are used for methanol evaporation/preheating. This appears to cause insignificant exergy loss in the heat transfer. There are differences between FIG. 9 for Case 2 and FIG. 10 for Case 4:

For example, less heat may be consumed for methanol reforming for Case 4 than for methanol decomposition for Case 2 (39 MWth vs. 61 MWth) because reaction heat for methanol reforming is less than for methanol decomposition.

The temperature difference in methanol reforming may be larger than in methanol decomposition (17° C. vs. 10° C.), because the first extracted steam stream pressure equals the methanol gas pressure in the reforming reactor (22 bar) and the saturated steam temperature is 217° C., 17° C. higher than the reaction temperature for Case 4.

The second variant of the conventional combined cycle 800, including post-combustion CO₂ capture is shown in FIG. 7 (including the dashed lines). A typical MEA unit 918 is used which needs a relatively large amount of low pressure steam for solvent regeneration. The steam is extracted from the second steam turbine 856. The parameters of the MEA unit are listed in Table 4.

The performance results of the post-combustion CO₂ capture combined cycle variant 800 are shown in Case 3 of Table 2. The net plant efficiency and net output are 41.5% HHV and 242.3 MW respectively.

Compared to Case 4 (apparatus 500), the efficiency of Case 3 (apparatus 800 variant two) is about 7% lower (resulting from 18.0% lower in fuel input and only 4.3% lower in net power output). This difference in efficiency may be attributable to at least one of the following two factors. First, in Case 4, a large amount of low grade heat provided by the first and second extracted steam streams (about 15% fuel energy) is upgraded to the higher energy level through methanol heating and conversion. Second, Case 3 needs a large amount of low pressure steam (69% of the second steam turbine flow) for solvent regeneration at the reboiler of the standard MEA unit, but Case 4 does not consume any steam for its CO₂ capture operations.

According to exergy analysis results in Table 3, exergy destruction in the gas turbine assembly combustor and CO₂ separator of Case 4 is lower than Case 3 by 8% and 5% respectively. However, Case 4 appears to have an extra 4% exergy destruction for methanol heating and reforming, which may be considered as the price paid for the reduction of exergy destruction in gas turbine assembly combustor as discussed above. Because of lower exergy input for Case 4, the exergy destruction percentage of gas turbine assembly compressor and turbine, HRSG and steam turbine is bigger than Case 3.

The following nomenclature is used in the above simulation information:
A=Energy level,
A_{f}=Energy level of fuel
A_{syn}=Energy level of syngas
Aₛₜₘ=Energy level of steam
Aₜₕ=Energy level at GT TIT
Q_{f}=Energy of fuel, MWth
Qₛₜₘ=Energy of steam, MWth
t=Temperature, ° C.
T=Temperature, ° K.
T₀=Reference temperature, ° K.
η_{c}=Carnot cycle efficiency
ΔT=Temperature difference, ° C.
ΔTₐₚᵣ=Approach temperature difference, ° C.
ΔTₚₚ=Pinch point temperature difference, ° C.

Based on the simulated performance, it is seen that integration of methanol indirect combustion and combined cycle may help facilitate increases in power generation apparatus efficiency including, for example, the 4.5% increase illustrated for Case 2.

The pre-combustion CO₂ capture combined cycle (apparatus 500) also appears to have attractive thermal performance. This performance may be due to one or both of the methanol indirect combustion process and the physical absorption for CO₂ separation. The modeled efficiency is higher than for conventional post-combustion CO₂ capture combined cycle (apparatus 800) by 7%. It also appears to reach the same efficiency level of conventional combined cycle without CO₂ capture. This provides a promising technology for methanol fuel power plant if tighter controls on greenhouse gas emissions are of concern.

While in the illustrative examples condensate extracted from the conversion apparatus 204 is supplied to the evaporation apparatus 202, in other examples the condensate may be re-introduced or used as an energy source in other locations within the apparatus 200.

The examples are described and illustrated in schematic configuration. Each apparatus may also include a plurality of additional components and hardware in addition to the features illustrated, including, for example, valves, pumps, storage tanks, sensors, gauges and control systems. Features that are described as being coupled or fluidly connected to each other need not be physically adjacent each other, and there may be a variety of valves, sensors, etc. positioned in stream between the features.

What has been described above has been intended to be illustrative of the invention and non-limiting and it will be understood by persons skilled in the art that other variants and modifications may be made without departing from the scope of the invention as defined in the claims appended hereto.

1. A methanol indirect combustion combined-cycle power generation apparatus comprising:
a) an evaporation apparatus operable to evaporate a liquid methanol input stream to provide a gaseous methanol stream, the evaporation apparatus comprising a liquid inlet for receiving the liquid methanol stream and a gas outlet for discharging the gaseous methanol stream;
b) a conversion apparatus connected downstream from the evaporation apparatus and operable to convert the gaseous methanol stream into a syngas combustion stream; the conversion apparatus comprising a gaseous methanol inlet fluidly coupled to the gas outlet of the evaporation apparatus and a syngas combustion stream outlet;
c) a gas turbine assembly fluidly coupled to the combustion stream outlet and configured to burn the syngas combustion stream, the gas turbine assembly having an exhaust outlet and being drivingly connectable to a first electric generator;
d) a heat recovery steam generator (HRSG) comprising an exhaust inlet fluidly coupled to the exhaust outlet and configured to receive an exhaust gas stream from the gas turbine assembly and to use the heat from the exhaust gas stream to generate steam, the HSRG comprising a first steam outlet and a second steam outlet;
e) a steam turbine assembly connected to and configured to receive steam from the HSRG and being drivingly connectable to at least a second electrical generator, the steam turbine assembly comprising:
i) a first steam turbine having a first steam inlet fluidly coupled to the first steam outlet on the HRSG, the first steam turbine comprising a first extraction outlet for extracting a first extracted steam stream from the first steam turbine and a first exhaust outlet, the first extraction outlet fluidly coupled to a first steam inlet on the conversion apparatus to route the first extracted steam stream to the conversion apparatus, the heat provided to the conversion apparatus via the first extracted steam stream being sufficient to facilitate conversion of the gaseous methanol stream into the combustion feed stream; and
ii) a second steam turbine having a second steam inlet fluidly coupled to the second steam outlet on the HRSG, the second steam turbine comprising a second extraction outlet for extracting a second extracted steam stream from the second steam turbine and a second exhaust outlet, the second extraction outlet fluidly coupled to a second steam inlet on the evaporation apparatus to route the second extracted steam stream to the evaporation apparatus, the heat provided to the evaporation apparatus via the second extracted steam stream being sufficient to evaporate the liquid methanol input stream.

2. The apparatus of claim 1, further comprising a first recycle condensate outlet on the conversion apparatus fluidly coupled to a first recycle condensate inlet on the evaporation apparatus to transfer a first recycle condensate stream from the conversion apparatus to the evaporation apparatus to provide additional heat to the evaporation apparatus.

3. The apparatus of claim 1, wherein the first recycle condensate stream is at a first recycle temperature that is hotter than the operating temperature of the evaporation apparatus.

4. The apparatus of claim 1, wherein the evaporation apparatus comprises a preheater, for receiving and pre-heating the liquid methanol input stream and an evaporator fluidly coupled downstream from the preheater for evaporating the liquid methanol input stream received from the preheater, with the evaporator comprising the second steam inlet for receiving the second extracted steam stream.

5. The apparatus of claim 4, further comprising a second recycle condensate outlet on the evaporator fluidly coupled to a second recycle condensate inlet on the preheater to transfer a second recycle condensate stream from the evaporator to the preheater to provide heat to pre-heat the liquid methanol input stream.

6. The apparatus of claim 1, wherein the conversion apparatus comprises a decomposition reactor and the syngas combustion stream produced by the decomposition reactor comprises hydrogen and carbon monoxide.

7. The apparatus of claim 1, wherein the conversion apparatus comprises a reformer and syngas combustion stream produced by the reformer comprises hydrogen and carbon dioxide.

8. The apparatus of claim 7, further comprising a separator apparatus fluidly connected between the reformer and the gas turbine assembly, the separator apparatus operable to separate carbon dioxide from the syngas combustion stream prior to introducing the syngas combustion stream to the gas turbine assembly.

11. The apparatus of claim 1, wherein the first extracted steam stream comprises between about 10 percent and about 70 percent of the quantity of steam provided to the first steam turbine.

12. The apparatus of claim 1, wherein the second extracted steam stream comprises between about 5 percent and about 35 percent of the quantity of steam provided to the second steam turbine.

9. The apparatus of claim 8, wherein the separator apparatus comprises a physical absorption carbon dioxide separator.

10. The apparatus of claims 1 to 9, further comprising a condenser apparatus fluidly coupled between the second exhaust outlet on the second steam turbine and the HRSG.

13. The apparatus of claim 1, wherein the first extracted steam stream is at a first temperature and the second extracted steam stream is at a second temperature, the second temperature being lower than the first temperature.

14. A method of generating power in a combined-cycle power generation plant, the method comprising:
a) evaporating a liquid methanol input stream to provide a gaseous methanol stream;
b) converting the gaseous methanol stream to a syngas combustion stream;
c) combusting the syngas combustion stream in a gas turbine assembly to drive a first electrical generator and generate an exhaust gas stream;
d) generating at least first and second steam streams using heat from the exhaust gas stream from the gas turbine assembly;
e) driving a first steam turbine using the first steam stream;
f) extracting a first extracted steam stream from the first steam stream and using the first extracted steam stream to provide the heat required for converting the gaseous methanol stream to the syngas combustion stream;
g) driving a second steam turbine using the second steam stream;
h) extracting a second extracted steam stream from the second steam turbine and using the second extracted steam stream to provide the heat required for evaporating the liquid methanol input stream; and
i) driving a second electrical generator using at least one of the first and second steam turbines.

15. The method of claim 14, further comprising withdrawing a first recycle condensate stream from the conversion apparatus and using the first recycle condensate stream to provide additional heat to evaporate the liquid methanol input stream.

16. The method of claim 14, wherein evaporating the liquid methanol input stream comprises passing the liquid methanol input stream through a preheater and an evaporator, and wherein the second extracted condensate stream provides heat to the evaporator.

17. The method of claim 16, further comprising withdrawing a second recycle condensate stream from the evaporator and using the second recycle condensate stream to provide heat to the preheater.

18. The method of claim 14, wherein converting the gaseous methanol stream to a syngas combustion stream comprises processing the gaseous methanol stream in a decomposition reactor so that the syngas combustion stream comprises hydrogen and carbon monoxide.

19. The method of claim 14, wherein converting the gaseous methanol stream to a syngas combustion stream comprises processing the gaseous methanol stream in a reformer so that the syngas combustion stream comprises hydrogen and carbon dioxide.

20. The method of claim 14, further comprising separating at least a portion of the carbon dioxide from the syngas combustion stream prior to combusting the syngas combustion stream in the gas turbine assembly.

21. The method of claim 14, wherein the at least a portion of the carbon dioxide is separated from the syngas combustion stream using a physical absorption carbon dioxide separator.

22. The method of claim 14, wherein the first extracted steam stream is extracted at a first temperature and the second extracted steam stream is extracted at a second temperature that is lower than the first temperature.

23. The method of claims 14 to 22, wherein the first extracted steam stream provides substantially all of the heat required to convert the gaseous methanol stream to the syngas combustion stream.
